(19) United States
(12) Patent Application Publication
(10) Pub. No.: US 2025/0274008 A1
(43) Pub. Date: Aug. 28, 2025

(54) CONNECTOR INTENDED TO MAKE AN ELECTRICAL CONNECTION BETWEEN AN ELECTRIC MOTOR AND AN INVERTER, AND SYSTEM COMPRISING SUCH A CONNECTOR

(71) Applicant: Valeo eAutomotive Germany GmbH, Erlangen (DE)

(72) Inventors: Vivek THANGARAJAN, Chennai (IN); Guillaume LUCOT, Creteil Cedex (FR); Nicolas DEVIE, Creteil Cedex (FR); Arnaud AVALET, Creteil Cedex (FR)

(73) Assignee: Valeo eAutomotive Germany GmbH, Erlangen (DE)

(21) Appl. No.: 19/060,208

(22) Filed: Feb. 21, 2025

(30) Foreign Application Priority Data
Feb. 23, 2024 (FR) FR2401774

(51) Int. Cl. H02K 5/22; H02M 7/00

(52) U.S. Cl. CPC H02K 5/225; H02M 7/003

(57) ABSTRACT

A connector intended to make an electrical connection between an electric motor and an inverter. The connector includes a plurality of connecting elements, each connecting element being intended to interlock with a complementary electrical connecting element of the electric motor in order to electrically connect them to one another. Also included is a plurality of connecting pins, each connecting pin being electrically connected to one of the connecting elements and configured to pass through an orifice formed in a casing of the inverter in order to come into contact with a track of an electrical interconnecting bar of the inverter. The orifice is formed in a wall of an inverter casing which includes the inverter.

### TECHNICAL FIELD

The invention relates to the field of electric rotary machines for electric vehicles, for example an electric motor, and to electric devices connected to these machines in an electric vehicle, for example an electric battery or an inverter. In particular, the invention relates to connectors between electric rotary machines and electric devices of electric vehicles.

### TECHNOLOGICAL BACKGROUND

An electric motor intended for an electric vehicle is generally powered by alternating current. An inverter is therefore required in order to transform the DC power supply of the electric battery to the AC power supply in order to make the AC electric motor run.

Generally, the inverter, the electric battery and the electric motor are positioned and connected together within the same casing on board the vehicle. Nevertheless, it is possible that the electric motor, the electric battery and the motor are not assembled together at the same time.

For example, it is possible that the AC electric motor is already mounted in a motor casing beforehand and that the aim is then to connect the inverter with the electric motor subsequently.

It is, then, often difficult to make the connection between the inverter and the electric motor.

### SUMMARY OF THE INVENTION

One idea behind the invention is to facilitate the electrical connection between an inverter and an electric motor.

According to one embodiment, the invention provides a connector intended to make an electrical connection between an electric motor and an inverter, the connector comprising:
a plurality of connecting elements, each connecting element being intended to interlock with a complementary electrical connecting element of the electric motor in order to electrically connect them to one another; and
a plurality of connecting pins, each connecting pin being electrically connected to one of the connecting elements and configured to pass through an orifice formed in a casing of the inverter in order to come into contact with a track of an electrical interconnecting bar of the inverter, the orifice being formed in a wall of an inverter casing comprising the inverter.

By virtue of these features, the connector makes it possible to connect the electric motor to the inverter more easily.

The double connection of the plurality of connecting elements of the connector with the complementary electrical connecting elements of the electric motor and of the connecting pins of the connector with the electrical interconnecting bar of the inverter is easier than the direct connection between the inverter and the electric motor. The connector also comprises electrical tracks electrically connecting the connecting elements to the connecting pins and also comprises an insulating body.

By virtue of the connector facilitating the connection, it is possible to make a blind connection of the inverter with the electric motor. The assembly operations are thus facilitated.

In addition, it is possible to connect only the plurality of connecting elements of the connector with the complementary electrical connecting elements of the electric motor in a first stage; then, in a second stage, to connect the connecting pins of the connector with the electrical interconnecting bar of the inverter. The reverse is also possible: in a first stage, only connect the connecting pins of the connector with the electrical interconnecting bar of the inverter; then, in a second stage, connect the plurality of connecting elements of the connector with the complementary electrical connecting elements of the electric motor. This makes it possible not to directly connect the inverter with the electric motor.

According to some embodiments, such a connector may comprise one or more of the following features.

According to one embodiment, the connecting elements and the connecting pins each comprise an insulating body and electrical conductors, each insulating body being notably made of a plastic material such as polymers.

Thus, the connector is more flexible than the inverter casing, the inverter and/or the electric motor, this making it possible to compensate for a clearance between the inverter and the electric motor.

According to one embodiment, the invention also provides a system comprising an inverter casing, a connector according to the invention attached to the inverter casing, an inverter housed inside the inverter casing and an electrical interconnecting bar which is housed inside the inverter casing, is electrically connected to the inverter and comprises tracks, the inverter casing comprising a plurality of orifices; each orifice being positioned opposite one of the tracks of the electrical interconnecting bar; each connector pin passing through one of the orifices and being in contact with one of the tracks.

According to one embodiment, the inverter casing forms a cover intended to close a motor casing inside which an electric motor is housed. In a particular example, the connector comprises fixing pastes to fix the connector to the motor casing.

According to one embodiment, the connecting elements of the connector are each adapted to interlock with a complementary electrical connecting element of the electric motor during a movement of closing the motor casing by the inverter casing.

Thus, it is possible to blindly assemble the inverter with the electric motor while at the same time closing the motor casing, which further facilitates the assembly operations.

According to one embodiment, the connecting elements of the connector are configured to interlock with the complementary electrical connecting elements in mutually parallel interlocking directions and the inverter casing is configured to close the motor casing in a closing movement directed in a closing direction; the closing direction being parallel to the interlocking directions.

According to one embodiment, the inverter casing and the motor casing are configured so that there is only one relative closed position.

According to one embodiment, the invention also provides a method for assembling a system according to the invention, the method comprising the following step:
pre-positioning the inverter casing with respect to the motor casing so that the connecting elements of the connector are opposite the complementary electrical connecting elements in mutually parallel interlocking directions;
moving the inverter casing with respect to the motor casing in a closing movement directed in a closing direction parallel to the interlocking directions to a relative closed position in which the inverter casing closes the motor casing and the connecting elements of the connector are interlocked with the complementary electrical connecting elements of the electric motor.

### BRIEF DESCRIPTION OF THE FIGURES

The invention will be better understood, and other aims, details, features and advantages thereof will become more clearly apparent over the course of the following description of several particular embodiments of the invention, given solely by way of illustration and not limitation, with reference to the appended drawings.

FIG. 1 is a schematic depiction of a motor casing which is closed by an inverter casing inside which an inverter 300 is housed and in which an electric motor and an electric battery are housed, the electric motor and the inverter being electrically connected by virtue of a connector.

FIG. 2 depicts an exploded perspective view of an inverter casing and a connector intended to make an electrical connection between an electric motor and an inverter.

FIG. 3 is a partial cross-sectional view along the axis III-III of FIG. 2.

FIG. 4 is a schematic depiction of a motor casing which is closed by an inverter casing inside which an inverter is housed and in which an electric motor and an electric battery are housed, the electric motor and the inverter being electrically connected by virtue of a first connector and the electric battery and the inverter being electrically connected by virtue of a second connector.

FIG. 5 depicts a connector in an other embodiment with flexible tracks.

FIG. 6 depicts the back side of the connector of FIG. 5.

FIG. 7 depicts a connector mounted on the motor (partially illustrated) and connected to the inverter, through the inverter casing.

### DESCRIPTION OF THE EMBODIMENTS

An electric or hybrid vehicle is equipped with electric mechanical propulsion. This electric propulsion comprises an electric motor 510, an electric battery 600 and an inverter 300.

The inverter 300 converts the direct current, delivered by the electric battery 600, into alternating current, which the electric motor 510 needs to drive the wheels of the electric vehicle.

For this purpose, it is therefore necessary to electrically connect the electric motor 510 with the inverter 300 and the electric battery 600 with the inverter 300.

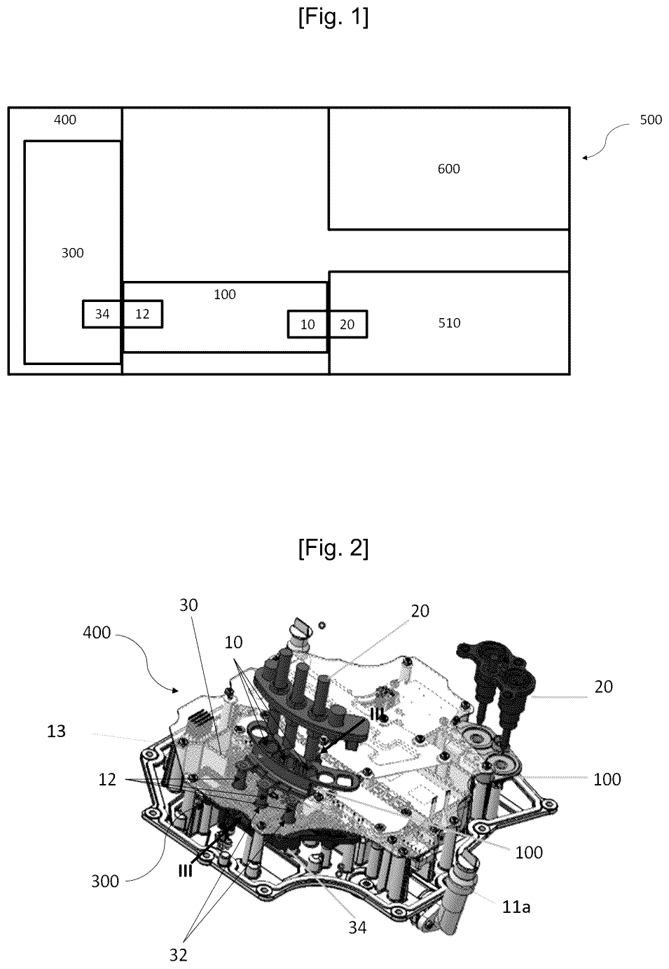

A connector 100, as illustrated in FIG. 2, is, notably, intended to make this electrical connection between the electric motor 510 and the inverter 300 as illustrated schematically in FIG. 1 (the connection between the electric battery 600 and the inverter 300 is not depicted in FIG. 1).

As illustrated in FIG. 2, the connector 100 comprises a plurality of connecting elements 10 and a plurality of connecting pins 12, each of which is electrically connected to one of the connecting elements 10. In one advantageous embodiment, the electric motor 510 is powered three-phase and the connector 100 comprises three connecting elements 10 and three connecting pins 12 which each correspond to one of the three phases U, V, W.

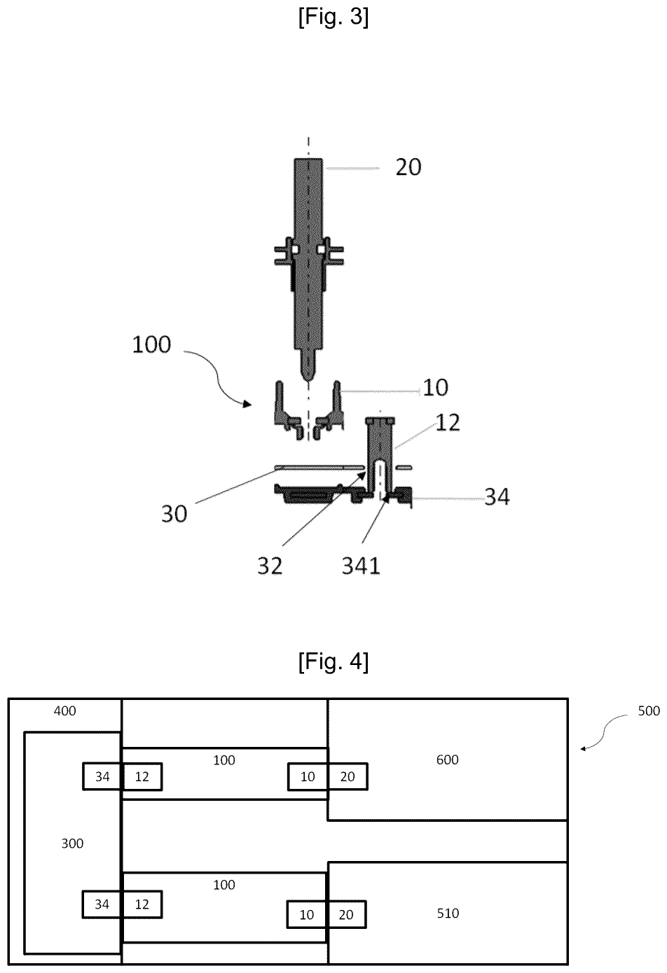

For example, FIG. 3 illustrates a connecting element 10 and a connecting pin 12 forming part of the connector 100.

The connecting elements 10 and the connecting pins 12 each comprise an insulating body and electrical conductors, each insulating body being made, for example, of a plastic material such as a polymer. For example, each insulating body is formed of polyphenylene sulfide (PPS), and notably polyphenylene sulfide filled with 30% glass fibre, or polybutylene terephthalate (PBT).

The connecting elements 10 make it possible to connect the connector 100 to the electric motor 510. As illustrated in FIG. 3, the connecting element 10 is intended to be positioned opposite a complementary electrical connecting element 20 of the electric motor 510 to be connected with the inverter 300.

The electrical connection between the connecting element 10 of the connector 100 and the complementary electrical connecting element 20 of the electric motor 510 can be made by a male-female assembly. In this case, according to a first embodiment, the connecting element 10 of the connector 100 may be the male assembly element or, according to a second embodiment, the complementary electrical connecting element 20 may be the male assembly element.

For example, in FIG. 3, the complementary electrical connector 20 of the motor is the male element of the assembly and is inserted inside the connecting element 10.

Other types of assembly between the connecting element 10 of the connector 100 and the complementary electrical connecting element 20 are possible. For example, by screwing.

The connecting pins 12 make it possible to connect the connector 100 to the interconnecting bar 34 of the inverter 300.

The inverter 300 and the interconnecting bar 34 are housed inside an inverter casing 400. A wall 30 of the inverter casing 400 comprises a plurality of orifices 32. FIG. 3 illustrates a portion of the wall 30 of the inverter casing 400 comprising an orifice 32.

As illustrated in FIG. 3, each connecting pin 12 is configured to pass through the orifice 32 and come into contact with one of the tracks 341 of the electrical interconnecting bar 34 of the inverter 300.

According to one embodiment, the tracks 341 integrate regions of contact with the connecting pins which are elastic: this makes it possible to avoid hyperstatic assembly of the connector 100 with the inverter 300. This may notably be a flexibility loop.

Thus, the connector 100 makes it possible to electrically connect the complementary electrical connecting element 20 of the electric motor 510 with the electrical interconnecting pin 34 connected to the inverter 300.

The connector 100 thus facilitates the assembly of the inverter 300 to the electric motor 510 of an electric vehicle since it makes it possible to connect non-coaxial electrical elements. Indeed, as illustrated in FIG. 3, the complementary electrical connecting element 20 is not necessarily aligned with the corresponding track 341.

In addition, the connector 100 makes it possible to compensate for, or recover, a clearance between the inverter 300 and the electric motor 510.

The connector 100 also comprises electrical tracks 11 electrically connecting the connecting elements 10 to the connecting pins 12 and also comprises an insulating body 13.

In the description, the axial direction is defined as the direction perpendicular to the inverter casing 400 through which the pins 12 go and the transversal directions are in the plane perpendicular to the axis.

FIG. 2 illustrates the connector 100 whose track first ends 11a are connected to the connecting pins 12. The assembly can be done by screwing or alternatively by soldering or crimping.

The connecting elements 10 are formed by holes in second ends 11b opposite the first ends 11a of the tracks. These holes form the female connectors for the male-female assembly with the complementary elements 20.

An insulating body 13 is molded onto the tracks so that the first ends 11a protrude from the insulating body 13 and the insulating body 13 has openings exposing the holes of the second ends 11b.

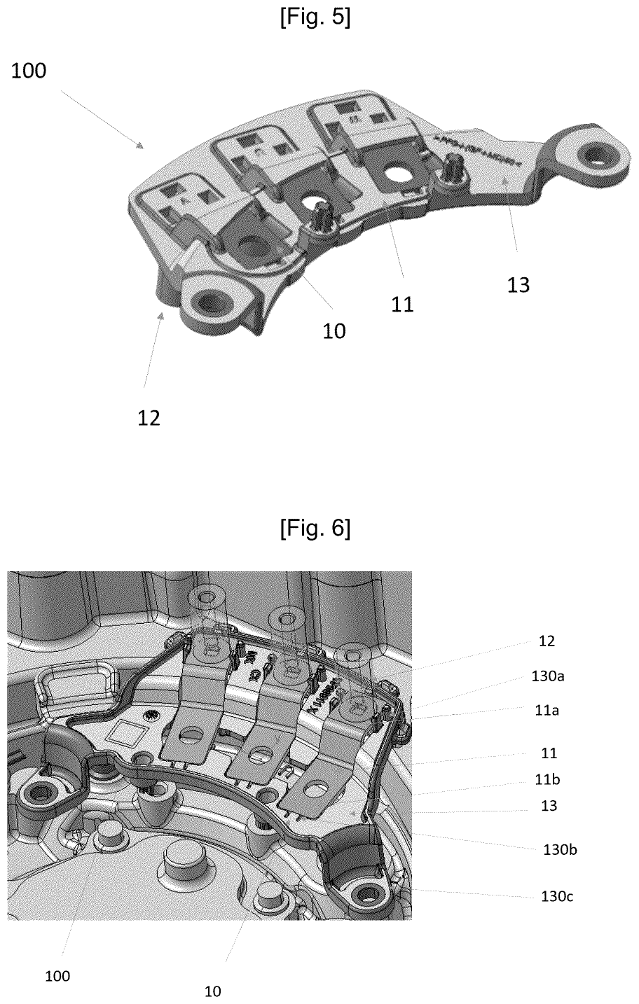

In another embodiment illustrated in FIG. 5, the tracks 11 are made of a flexible material, for example multilayer, preferably comprising copper.

In this embodiment, the tracks 11 are mounted on the insulating body 13 of the connector 100, for example by clipping, as illustrated in FIG. 6. The insulating body 13 can advantageously include a system of lugs 130a cooperating with the tracks to maintain it axially and transversally, with a possible assembly clearance. A second attachment system with tabs 130b can also be used in addition to the first system.

The body covers the tracks axially on one side only.

As illustrated in FIG. 5, the body 13 axially covers the tracks with the exception of the end holes 11b and a region around the holes. The ends 11b, being locally unconstrained axially by the insulating body 13, can thus more easily deform.

The insulating body 13 includes a common window opposite all the holes of the ends 11b.

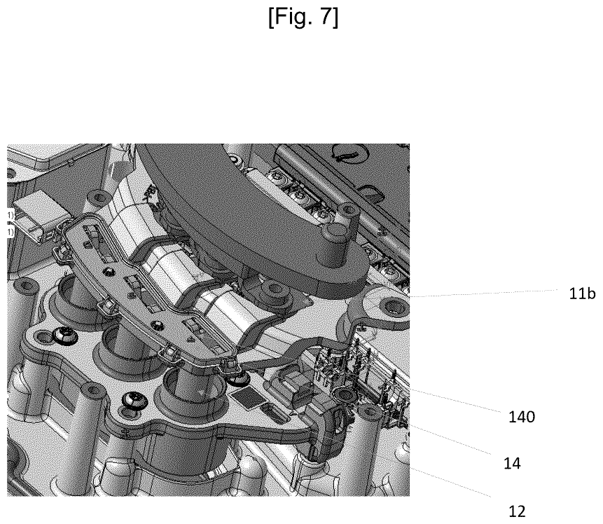

A cover 14 may optionally be provided as shown in FIG. 7, axially covering the insulating body 13 above the connection zone between the ends 11a of the tracks and the connecting pins 12.

The cover 14 is, for example, clipped onto the insulating body 13. Pads 140 of the cover extend through orifices of the insulating body 13 to press on the tracks 11 in the areas of connection with the pins 12.

The insulating body 13 of the connector is fixed to the motor. The insulating body can advantageously include fixing pastes 130c for screws, allowing the connector 100 to be mounted on the motor. During assembly, in particular directly by means of screws, conductors coming from the motor (electrical connecting elements complementary to the electric motor 20) are inserted into the holes of the tracks at the ends 11b (connecting elements of the connector 10). The connecting pins 12 are then assembled with the electrical interconnection bar of the inverter 34 (blind assembly with the inverter casing 400).

The connector 100 can be attached to an inverter casing 400 and only connected to the interconnecting bar 34. FIG. 2 illustrates such an inverter casing 400.

In FIG. 2, the inverter casing 400 comprises the inverter 300 housed within and an interconnecting bar 34—comprising a plurality of tracks 341—electrically connected to the inverter 300.

The inverter casing 400 comprises a plurality of orifices 32 and each of these orifices 32 is positioned opposite one of the tracks 341 of the electrical interconnecting bar 34. Thus, each connecting pin 12 of the connector 100 passes through one of the orifices 32 and is then in contact with one of the tracks 341.

The inverter casing 400 is then ready to be connected to the electric motor 510. By virtue of the connector 100, this connection with the electric motor 510 can be made during a blind assembly between the inverter casing 400 and a motor casing 500 inside which the electric motor 510 and the electric battery 600 are housed.

The inverter casing 400 then forms a cover intended to close this motor casing 500. The connecting elements 10 of the connector 100 are each adapted to interlock with a complementary electrical connecting element 20 of the electric motor 510 during the movement of closing the motor casing 500 by the inverter casing 400.

For example, the connecting elements 10 of the connector 100 interlock with the complementary electrical connecting elements 20 in mutually parallel interlocking directions.

In order to be able to connect the connecting elements 10 of the connector 100 with the complementary electrical connecting elements 20 of the motor, the closing direction in which the inverter casing 400 is configured to close the motor casing 500 must be parallel to the interlocking directions.

For this purpose, the inverter casing 400 is pre-positioned with respect to the motor casing 500 so that the connecting elements 10 of the connector 100 are opposite the complementary electrical connecting elements 20 of the electric motor 510 in mutually parallel interlocking directions.

Thus, during a closing movement in which the inverter casing 400 is moved with respect to the motor casing 500 in a closing direction parallel to the interlocking directions, the connecting elements 10 of the connector 100 interlock with the complementary electrical connecting elements 20. Thus, the inverter casing 400 and the motor casing 500 are in a relative closed position in which the inverter casing 400 closes the motor casing 500.

Thus, the assembly of the inverter 300 with the electric motor 510 can be carried out blindly since the movement of closing the motor casing 500 by the inverter casing 400 makes it possible to interlock the connecting elements 10 of the connector 100 with the complementary electrical connecting elements 20 of the electric motor 510.

According to one embodiment, the inverter casing 400 and the motor casing are configured so that there is only one relative closed position.

According to one embodiment, the one or more complementary electrical connecting elements 20 are attached to the motor casing 500 by a threaded connection.

A second connector 100 can also be used to connect the inverter 300 with the electric battery 600. FIG. 4 illustrates this embodiment.

In this case, the connector 100 intended to make the electrical connection between the electric motor 510 and the inverter 300 of the electric vehicle is a first connector 100.

In this same case, similarly to the electric motor 510, the electric battery 600 comprises a plurality of complementary connecting elements 20 adapted to be connected with the plurality of connecting elements 10 of the connector 100.

As illustrated in FIG. 4, a second interconnecting bar 34 may be provided in order to connect the inverter 300 with the second connector 100. The interconnecting bar 34 connecting the inverter 300 with the first connector 100 is then a first interconnecting bar 34.

Similarly to the first connector 100, the second connector 100 can be electrically connected to the inverter 300, i.e. the connecting pins 12 of this second connector 100 are in contact with a track 341 of a connecting bar 34 of the inverter 300.

Although the invention has been described in connection with several particular embodiments, it is quite obvious that it is in no way limited thereto and that it comprises all the technical equivalents of the means described and combinations thereof where these fall within the scope of the invention.

The use of the verb “comprise” or “include” and of its conjugate forms does not exclude the presence of elements or steps other than those set out in a claim.

In the claims, any reference sign between parentheses should not be interpreted as limiting the claim.

1. Connector intended to make an electrical connection between an electric motor and an inverter, the connector comprising:
a plurality of connecting elements, each connecting element being intended to interlock with a complementary electrical connecting element of the electric motor in order to electrically connect them to one another; and
a plurality of connecting pins, each connecting pin being electrically connected to one of the connecting elements and configured to pass through an orifice in order to come into contact with a track of an electrical interconnecting bar of the inverter, the orifice being formed in a wall of an inverter casing comprising the inverter.

2. Connector according to claim 1, wherein the connecting elements and the connecting pins each comprise an insulating body and electrical conductors, each insulating body being notably made of a plastic material such as polymers.

3. System comprising an inverter casing, a connector according to claim 2 attached to the inverter casing, an inverter housed inside the inverter casing and an electrical interconnecting bar which is housed inside the inverter casing, is electrically connected to the inverter and comprises tracks, the inverter casing comprising a plurality of orifices;
each orifice being positioned opposite one of the tracks of the electrical interconnecting bar;
each connecting pin passing through one of the orifices and being in contact with one of the tracks.

4. System according to claim 3, wherein the inverter casing forms a cover intended to close a motor casing inside which an electric motor is housed.

5. System according to claim 4, wherein the connecting elements of the connector are each adapted to interlock with a complementary electrical connecting element of the electric motor during a movement of closing the motor casing by the inverter casing.

6. System according to claim 4, wherein the connecting elements of the connector are configured to interlock with the complementary electrical connecting elements in mutually parallel interlocking directions and wherein the inverter casing is configured to close the motor casing in a closing movement directed in a closing direction and wherein the closing direction is parallel to the interlocking directions.

7. System according to claim 4, further comprising a motor casing and an electric motor housed in the motor casing, the electric motor comprising complementary electrical connecting elements; the inverter casing and the motor casing configured to be positioned in a relative closed position in which the connecting elements of the connector are interlocked with the complementary electrical connecting elements of the electric motor.

8. System according to claim 7, wherein the inverter casing and the motor casing are configured so that there is only one relative closed position.

9. System according to claim 8, wherein the one or more complementary electrical connecting elements are attached to the motor casing by a threaded connection.

10. Method for assembling a system according to claim 7, the method comprising the following step:
pre-positioning the inverter casing with respect to the motor casing so that the connecting elements of the connector are opposite the complementary electrical connecting elements in mutually parallel interlocking directions;
moving the inverter casing with respect to the motor casing in a closing movement directed in a closing direction parallel to the interlocking directions to a relative closed position in which the inverter casing closes the motor casing and the connecting elements of the connector are interlocked with the complementary electrical connecting elements of the electric motor.

11. System comprising an inverter casing, a connector according to claim 2 attached to the inverter casing, an inverter housed inside the inverter casing and an electrical interconnecting bar which is housed inside the inverter casing, is electrically connected to the inverter and comprises tracks, the inverter casing comprising a plurality of orifices;
each orifice being positioned opposite one of the tracks of the electrical interconnecting bar;
each connecting pin passing through one of the orifices and being in contact with one of the tracks.

12. System according to claim 5, wherein the connecting elements of the connector are configured to interlock with the complementary electrical connecting elements in mutually parallel interlocking directions and wherein the inverter casing is configured to close the motor casing in a closing movement directed in a closing direction and wherein the closing direction is parallel to the interlocking directions.

13. System according to claim 5, further comprising a motor casing and an electric motor housed in the motor casing, the electric motor comprising complementary electrical connecting elements; the inverter casing and the motor casing configured to be positioned in a relative closed position in which the connecting elements of the connector are interlocked with the complementary electrical connecting elements of the electric motor.

14. System according to claim 6, further comprising a motor casing and an electric motor housed in the motor casing, the electric motor comprising complementary electrical connecting elements; the inverter casing and the motor casing configured to be positioned in a relative closed position in which the connecting elements of the connector are interlocked with the complementary electrical connecting elements of the electric motor.
